(19) United States
(12) Patent Application Publication
(10) Pub. No.: US 2026/0040330 A1
(43) Pub. Date: Feb. 5, 2026

(54) METHODS, TERMINAL DEVICES AND COMPUTER READABLE MEDIUM FOR COMMUNICATION

(71) Applicant: NEC CORPORATION, Tokyo (JP)

(72) Inventors: Ying ZHAO, Beijing (CN); Zhaobang MIAO, Beijing (CN); Jin YANG, Beijing (CN); Gang WANG, Beijing (CN)

(73) Assignee: NEC CORPORATION, Tokyo (JP)

(21) Appl. No.: 19/099,095

(22) PCT Filed: Jul. 29, 2022
(86) PCT No.: PCT/CN2022/109267

§ 371 Date: Jan. 28, 2025

(51) Int. Cl. H04W 72/25; H04W 28/26; H04W 72/0453

(52) U.S. Cl. CPC H04W 72/25; H04W 28/26; H04W 72/0453

(57) ABSTRACT

Example embodiments of the present disclosure relate to resource indication/reservation for flexible and reliable sidelink transmission. A first terminal device senses a plurality of spectrum sections to be idle for at least one sidelink transmission between the first terminal device and a second terminal device in an unlicensed spectrum; and transmits, to the second terminal device, information indicating the plurality of spectrum sections for a resource allcoation. Through this solution, several enhancements related to resource indication/reservation for flexible and reliable sidelink transmissions on unlicensed spectrum are provided.

### FIELD

Embodiments of the present disclosure generally relate to the field of communications, and in particular, to methods, terminal devices and computer readable medium for sidelink communication.

### BACKGROUND

Sidelink in unlicensed spectrum (SL-U) is studied in Release 18 sidelink evolution work item of the 3rd Generation Partnership Project (3GPP). And the term “shared spectrum” represents the same meaning of unlicensed spectrum. The scheme of SL-U should be based on New Radio (NR) sidelink and NR unlicensed (NR-U). The scheme considers maximum reuse of NR-U channel access mechanism and sidelink framework.

Increased sidelink data rate is motivated by applications such as sensor information (video) sharing between vehicles with high degree of driving automation. Commercial use cases could require data rates in excess of what is possible in Rel-17. Increased data rate can be achieved with the support of sidelink carrier aggregation and sidelink over unlicensed spectrum. Furthermore, by enhancing the sidelink operation, increased data rate can be more efficiently supported. While the support of new carrier frequencies and larger bandwidths would also allow improving its data rate, the main benefit would come from making sidelink more applicable for a wider range of applications. More specifically, with the support of unlicensed spectrum and the enhancement, sidelink will be in a better position to be implemented in commercial devices.

### SUMMARY

In general, example embodiments of the present disclosure provide a solution for sidelink resource allocation on unlicensed spectrum. Embodiments that do not fall under the scope of the claims, if any, are to be interpreted as examples useful for understanding various embodiments of the disclosure.

In a first aspect, there is provided a method for communication. The method comprises: sensing, at a first terminal device, a plurality of spectrum sections to be idle for at least one sidelink transmission between the first terminal device and a second terminal device operating in an unlicensed spectrum; and transmitting, to the second terminal device, information indicating the plurality of spectrum sections for a resource allocation.

In a second aspect, there is provided a method for communication. The method comprises: receiving, at a second terminal device from a first terminal device, information indicating a plurality of spectrum sections for a resource allocation; and performing at least one sidelink transmission with the first terminal device on the plurality of spectrum sections in an unlicensed spectrum.

In a third aspect, there is provided a first terminal device. The first terminal dev ice comprises a processor; and a memory storing computer program code; the memory and the computer program code configured to, with the processor, cause the terminal device to perform the method according to the first aspect.

In a fourth aspect, there is provided a second terminal device. The second terminal device comprises a processor; and a memory storing computer program code; the memory and the computer program code configured to, with the processor, cause the network device to perform the method according to the second aspect.

In a fifth aspect, there is provided a computer readable medium. The computer readable medium comprises program instructions for causing an apparatus to perform at least the method according to the first and second aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A to 1B illustrate example environments in which example embodiments of the present disclosure can be implemented;

FIG. 2 illustrates an example of resource structure for sidelink communication according to some example embodiments of the present disclosure;

FIG. 3 illustrates another example of resource structure for sidelink communication according to some example embodiments of the present disclosure;

FIG. 4 illustrates a flowchart of an example method implemented at a first terminal device according to some example embodiments of the present disclosure;

FIG. 5A to 5B illustrates an example of resource allocation for sidelink communicate according to some other example embodiments of the present disclosure;

FIG. 6A to 6B illustrates an example of resource allocation for sidelink communicate according to some other example embodiments of the present disclosure;

FIG. 7A to 7B illustrates an example of resource allocation for sidelink communicate according to some other example embodiments of the present disclosure;

FIG. 8A to 8B illustrates an example of resource allocation for sidelink communicate according to some other example embodiments of the present disclosure;

FIG. 9 illustrates an example of resource allocation for sidelink communicate according to some other example embodiments of the present disclosure;

FIG. 10A to 10B illustrates an example of resource allocation for sidelink communicate according to some other example embodiments of the present disclosure;

FIG. 11 illustrates an example of resource allocation for sidelink communicate according to some other example embodiments of the present disclosure;

FIG. 12 illustrates an example of resource allocation for sidelink communicate according to some other example embodiments of the present disclosure;

FIG. 13A to 13B illustrates an example of resource allocation for sidelink communicate according to some other example embodiments of the present disclosure;

FIG. 14 illustrates a flowchart of an example method implemented at a first terminal device according to some example embodiments of the present disclosure;

FIG. 15 illustrates a flowchart of another example method implemented at a second terminal device according to some other example embodiments of the present disclosure; and

FIG. 16 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The terminal device′ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHZ-7125 MHZ), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes. The network device may have the function of network energy saving, Self-Organizing Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device in sidelink communication can transmit related data with each other. As used herein, the term “resource” or “transmission resource” may refer to any resource for performing a communication, such as a resource in time domain, a resource in frequency domain, a resource in space domain, a resource in code domain, or any other resource enabling a communication, and the like. In the following, a resource in frequency domain or time domain will be used as an example of a transmission resource for describing some example embodiments of the present disclosure. It is to be understood that example embodiments of the present disclosure are equally applicable to other resources in other resource domains.

As used herein, the term “sidelink” refers to a direct communication link and/or discovery link between two or more terminal devices, the term “PC5” refer to an interface which enables communication and/or discovery between two or more terminal devices without traversing any network node and the term “PC5 direct link” refers to the link established between two or more terminal devices over the PC5 interface. The term “sidelink” and “PC5 direct link” described herein are equivalent to each other.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

The principle in sidelink operation on licensed spectrum is considering maximum reuse of NR-U channel access mechanism and sidelink framework. But the problems is, for the SL-U transmission on multiple resource block (RB) sets (listen before talk (LBT) sub-bands in frequency domain), how to indicate resource allocation and reservation to adapt to certain channel access procedure on unlicensed spectrum and resource allocation method.

This disclosure provides the schemes for sidelink transmission on multiple RB sets based on the potential enhancement to legacy multi-channel channel access procedure, to provide more frequency resource for LBT-based transmission and counter the impact of uncertainty of LBT procedure. The disclosure provides the method about enhancements on resource indication/reservation for the transmissions on contiguous RB sets with aligned starting symbols within a slot. The disclosure also provides the method about enhancements on resource indication/reservation for the transmissions on noncontiguous RB sets with aligned starting symbols within a slot. The disclosure also provides the method about considering enhancements on resource indication/reservation for the transmissions on RB sets with misaligned starting symbols within a slot. The solution also provides the methods about enhancements on resource indication/reservation for the transmissions on the same RB sets across consecutive slots within maximum channel occupancy (MCO).

Through this disclosure, several kinds of new definition and enhancement related to resource indication/reservation for flexible and reliable sidelink transmissions on multiple RB sets in unlicensed spectrum are provided. Example embodiments of the present disclosure will be described in detail below with reference to the accompanying drawings.

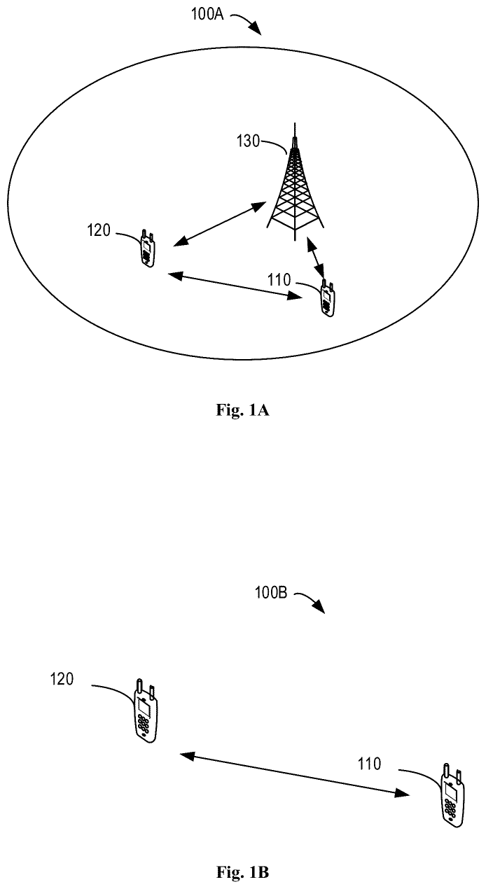

FIG. 1A illustrates an example environment 100A in which example embodiments of the present disclosure can be implemented. The environment 100, which may be a part of a communication network, may comprise a terminal device 110, a terminal device 120, and a network device 130. It is to be understood that the number of devices in FIG. 1 is given for the purpose of illustration without suggesting any limitations to the present disclosure. The communication network 100 may include any suitable number of network devices and/or terminal devices adapted for implementing embodiments of the present disclosure. In the example of FIG. 1, the network device 130 provides a serving area called as cell 140. The terminal device 110 and 120 is within the coverage of the cell 140. FIG. 1B also illustrates an example environment 100B in which example embodiments of the present disclosure can be implemented. The environment 100, which may be a part of a communication network, may comprise a terminal device 110 and a terminal device 120. The terminal device 110 and terminal device 120 may be out of the coverage of a network device.

As shown in FIGS. 1A and 1B, the terminal device 110 and the terminal device 120 can communicate with each other via sidelink communication. Sidelink communication is a wireless radio communication directly between two or more terminal devices, such as two or more terminal devices among the terminal device 110 and the terminal device 120. In this type of communication, the two or more terminal devices that are geographically proximate to each other can directly communicate without going through the network device 130 or through a core network. Data transmission in sidelink communication is thus different from typical cellular network communications, in which a terminal device transmits data to the network device 130 (i.e., uplink transmissions) or receives data from the network device 130 (i.e., downlink transmissions). In sidelink communication, data is transmitted directly from a source terminal device (such as the terminal device 110) to a target terminal device (such as the terminal device 120) through the Unified Air Interface, e.g., PC5 interface, (i.e., sidelink transmissions), as shown in FIGS. 1A and 1B.

Communications in the environment 100A and 100B may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Sidelink communication can provide several advantages, including reducing data transmission load on a core network, system resource consumption, transmission power consumption, and network operation costs, saving wireless spectrum resources, and increasing spectrum efficiency of a cellular wireless communication system.

In a sidelink communication system, the sidelink resource is used to transmit information between terminal devices. According to application scenarios, service types, etc., a sidelink communication manner includes but is not limited to device to device (D2D) communication, Vehicle-to-Everything (V2X) communication, etc.

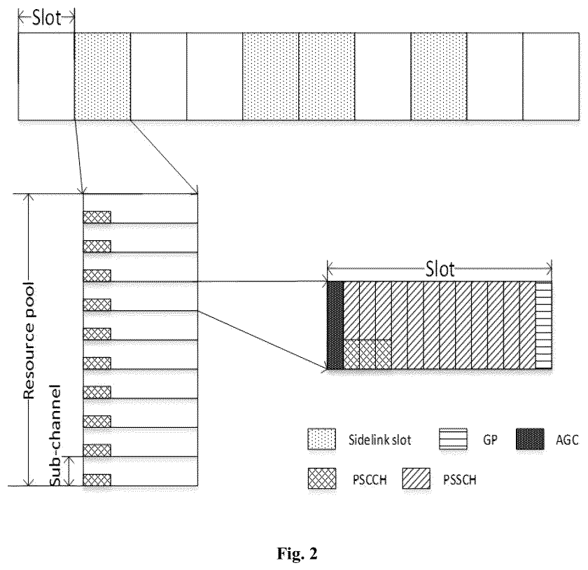

For sidelink communications, a terminal device uses resources in sidelink resource pools to transmit or receive signals. As shown in FIG. 2, the sidelink resource pools include resources in time domain and frequency domain, which are dedicated resources of the sidelink communication, or shared by the sidelink communication and a cellular link. In a sidelink resource pool which may contain multiple slots and resource blocks (RBs), and all or part of the symbols in a slot can be used for sidelink transmission. The terminal device 110 and terminal device 120 may use sidelink channels to transmit sidelink signaling or information. RBs in the resource pool may be divided into RB sets. Each RB set contains consecutive RBs. A terminal device may use one or more RB sets as resource to transmit sidelink data.

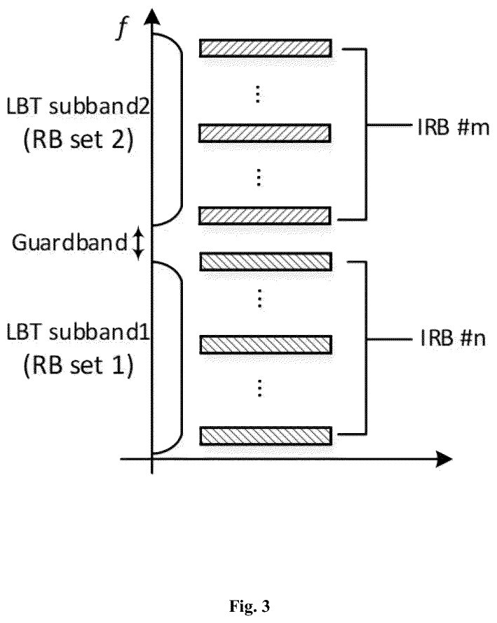

Interlace of resource block (IRB) is used as a frequency resource unit for NR-U uplink and sidelink communication in unlicensed spectrum. FIG. 3 illustrates an example of an RB set and IRB in accordance with some embodiments of the present disclosure. There may be a guard band between two adjacent RB sets.

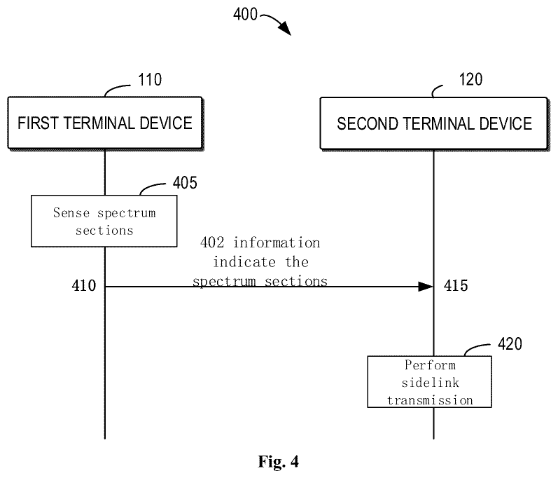

Reference is now made to FIG. 4, which shows a signaling flow 400 for sidelink resource allocation in communication according to some example embodiments of the present disclosure. For the purpose of discussion, the signaling flow 400 will be described with reference to FIG. 1. The signaling flow 400 may involve the terminal device 110, the terminal devices 120. Further, it is to be understood that the order of the signalings and actions in FIG. 4 is shown only for the purpose of illustrations. The order of the signalings and actions illustrated in signaling chart 400 may be performed in any suitable order adapted for implementing embodiments of the present disclosure.

In the signaling flow 400, the first terminal device 110 senses 405 a multiple of spectrum sections to be idle for sidelink transmission. The transmission is between the first terminal device 110 and second terminal device 120 in an unlicensed spectrum. Then the first terminal device 110 send 410 the information (402) to indicate the spectrum sections to the second terminal device 120. Upon the second terminal device receives 415 the information (402), the first terminal device 110 and second terminal device 120 may perform sidelink communication.

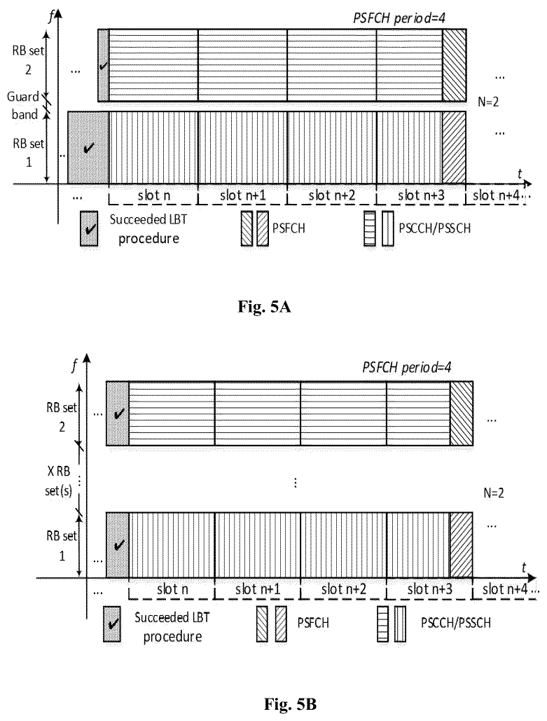

In some embodiments, multiple resources locating at different frequency bands may be allocated to terminal device 110 or terminal device 120 for physical sidelink control channel (PSCCH)/physical sidelink shared channel (PSSCH) transmission (may or may not IRB-based), namely the terminal device 110 or terminal device 120 may perform a transmission on a set of respective channels, such as one or multiple RB sets or LBT sub-bands. The transmission on each channel shall satisfy the occupied channel bandwidth (OCB) requirement according to the NR-U regulations. As per different channel access procedure and resource allocation scheme in sidelink, a set of N channels (RB sets) for transmission may be adjacent to each other in frequency domain (except the guard band), as shown in FIG. 5A. Alternatively, the RB sets for transmission may be separately distributed with a gap between each other within a resource pool, as shown in FIG. 5B.

In some embodiments, there may be two schemes for resource indication/reservation related information carrying based on terminal 110's and/or terminal 120's sensing/reservation on resource. The scheme 1 is inserting new field(s) with the additional information to legacy sidelink control information (SCI) format in sidelink, or replacing the corresponding field by redefined/enhanced information (with the same or different size). The scheme 2 is introducing the new SCI format(s) (such as SCI format 1-X and/or SCI format 2-D)/medium access control (MAC)-control element (CE) to convey the enhanced SCI information for intended transmission on multiple RB sets. The new SCI format also may include part information of legacy SCI format.

Contiguous RB Sets with Aligned Starting Symbols

In some embodiments, the information includes an indication being determined based on the number of resource reservations and the number of the multiple of spectrum sections in a resource pool. The indication is for a plurality of contiguous spectrum sections of the plurality of spectrum sections. And the transmissions on the plurality of contiguous spectrum sections have aligned starting symbols within a sidelink slot.

For example, after sensing N contiguous RB sets to be idle for the transmissions with aligned starting symbols on all RB sets (as a set of channels C wherein each channel corresponds to a RB set) by terminal 110, the corresponding resource indication/reservation in SCI and/or MAC-CE may be enhanced/introduced to indicate the resource assignment for contiguous RB sets. The new content may be introduced in 3rd Generation Partnership Project Technical Specification (3GPP TS) as below:

If higher layer parameter useInterlacePSCCH-PSSCH/useInterlaceSL is configured, 5 +
Y or 6 + Y bits may be introduced to SCI format to provide the enhanced frequency
domain resource assignment if the SCS for the resource pool is 30 kHz or 15 kHz
respectively and interlaced resource blocks is configured/enabled for sidelink
transmission.
$The value of Y is determined by ⌈ {log}_{2} ( \frac{{N}_{RB - set}^{Res - Pool} ( {N}_{RB - set}^{RE - Pool} + 1 )}{2} ) ⌉ when the value of the$
higher layer parameter sl-MaxNumPerReserve is configured to 2, otherwise
$⌈ {log}_{2} ( \frac{{N}_{RB - set}^{Res - Pool} ( {N}_{RB - set}^{Res - Pool} + 1 ) ( 2 {N}_{RB - set}^{Res - Pool} + 1 )}{6} ) ⌉ bits when the value of the higher layer$
$parameter sl - MaxNumPerReseve is configured to 3 , where {N}_{RB - set}^{Res - Pool} is the number$
of RB sets contained in the resource pool of the active BWP.

| | |
|---|---|
| - | If sl-MaxNumPerReserve is 2 then for FRIV in RB set granularity |
| - | $F R I V = {n}_{RB - set , 1}^{start} + {\sum }_{i = 1}^{{L}_{RB - set} - 1} ( {N}_{RB - set}^{Res - Pool} + 1 - i )$ |
| - | If sl-MaxNumPerReserve is 3 then for FRIV in RB set granularity |
| - | $F R I V = {n}_{RB - set , 1}^{start} + {n}_{RB - set2}^{start} \cdot ( {N}_{RB - set}^{Res - Pool} + 1 - {L}_{RB - set} ) + {\sum }_{i = 1}^{{L}_{RB - set} - 1} {( {N}_{RB - set}^{Res - Pool} + 1 - i )}^{2}$ |

where

| | |
|---|---|
| - | ${n}_{RB - set , 1}^{start} denotes the starting RB set index for the second resource$ |
| - | ${n}_{RB - set , 2}^{start} denotes the starting RB set index for the third resource$ |
| - | L_{RB-set} denotes the number of RB sets scheduled or configured for |
| | transmission |

It is noted that the parameter

$$“ {N}_{RB - set}^{Res - Pool} ”$$

and “L_{RB-set}” may be predefined.

In some embodiments, the information indicates indexes of a plurality of interlaced spectrums in each of the plurality of spectrum sections, and the indicated indexes of the plurality of interlaced spectrums are common to at lest one of the plurality of spectrum sections and the at least one reserved resource. And the information further indicates a plurality of interlaced spectrums in each of the plurality of spectrum sections individually. Additionally or alternatively, the information further indicates a plurality of interlaced spectrum in each of the at least one reserved resource individually.

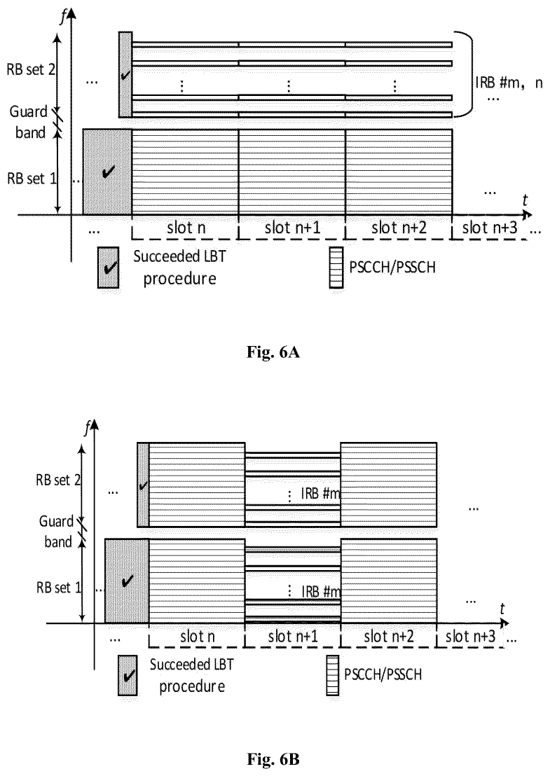

For example, the assigned interlace indices (5 or 6 bits) may be common to all RB sets and all reservations, namely the interlaced RB(s) marked by the same indices within each RB set are allocated to the UE. Alternatively, considering the efficient resource utilization, separate interlace indices may be applied to each RB set in C, namely different interlaced RB(s) within each RB set are allocated to the UE, as shown in FIG. 6A. Then 5*N or 6*N bits indicate the interlace indices per RB set. Further, considering the multi-slot occupancy, separate interlace indices may be applied to each reservation, namely different interlaced RB(s) related to each reservation are indicated, as shown in FIG. 6B. Then 2*(5 or 6) or 3*(5 or 6) bits indicate the interlace indices per reservation. If the higher layer parameter useInterlacePSCCH-PSSCH/useInterlaceSL is not configured, interlace indices indication filed is omitted, 0 bit needed.

In some embodiments, the information comprises at least one channel occupancy (CO) indication for the at least one sidelink transmission. And the at least one CO indication comprises a CO indication common to the transmissions on at least one of the plurality of spectrum sections and the at least one reserved resource. Additionally or alternatively, the at least one CO indication comprises a plurality of CO indications used for indicating COs for the plurality of spectrum sections separately.

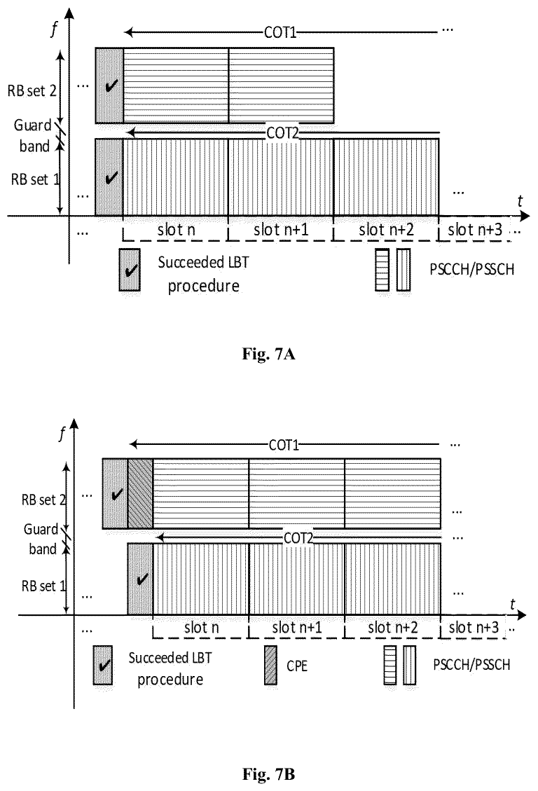

For example, the CO indication based on channel access procedure can be introduced in SCI. It may contain at least but not limited to channel occupancy starting point indication and remaining channel occupancy duration indication. It may be common to all RB sets and all reservation. Alternatively, considering the varied bandwidth requirement over consecutive slots, separate CO may be indicated for each RB set if the Tx UE would not occupy all RB sets across multiple slots, as shown in FIG. 7A. Correspondingly, different number of RB sets for each reservation could be indicated. Further, if the cyclic prefix extension (CPE) based method is applied to channel access procedure(s) on multiple RB sets to align the starting symbols of transmissions on all RB sets, there may be different transmission starting points on separate RB sets, as shown in FIG. 7B. Hence, separate CO may be indicated for each RB set.

In some embodiments, the information indicates at least one of the following parameters for each of the plurality of spectrum sections individually: a resource reservation period; a modulation and coding scheme (MSC) or an additional MCS table indicator.

As an example, For the other information in legacy SCI, such as resource reservation period, MCS, additional MCS table indicator and etc., these parameters may be common to all RB sets and all reservations, and traditionally indicated as those of legacy SCI. Alternatively, if different RB sets correspond to different transactions or PDUs and considering the enhanced/introduced indication, these parameters may be separately indicated for each RB set and/or for each reservation.

In some embodiments, the information is transmitted through a selected spectrum section of the plurality of spectrum sections. The selected spectrum section is a lowest spectrum section in frequency domain or a randomly selected spectrum section in the plurality of spectrum sections. Alternatively, the information may be transmitted through the plurality of spectrum sections, and a spectrum section of the plurality of spectrum sections carries a corresponding part of the information associated with the spectrum section.

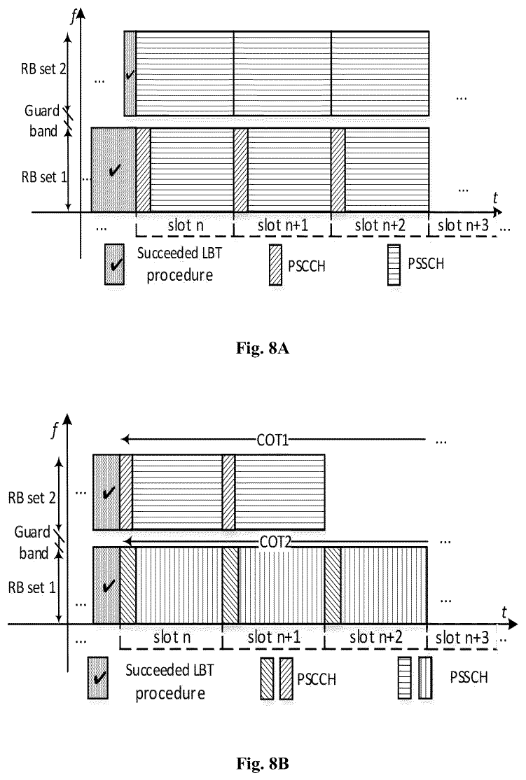

For example, the SCI may be conveyed through only one RB set which can be the lowest RB set in frequency domain, or a randomly selected RB set in the set of channels C, as shown in FIG. 8A. Then, the single SCI shall carry all resource indications/reservations on all RB sets, the information related to each RB set may be varied. Alternatively, the SCI may be equally applied to all RB sets in C to improve the performance of SCI reception for Rx UE by diversity reception, as shown in FIG. 8B. The SCI conveyed on each RB set may be varied.

Noncontiguous RB Sets with Aligned Starting Symbols

In some embodiments, the information includes an indication being determined based on the number of the multiple of spectrum sections in a resource pool, the indication being for a plurality of noncontiguous spectrum sections of the plurality of spectrum sections. And the transmissions on the plurality of noncontiguous spectrum sections have aligned starting symbols within a sidelink slot.

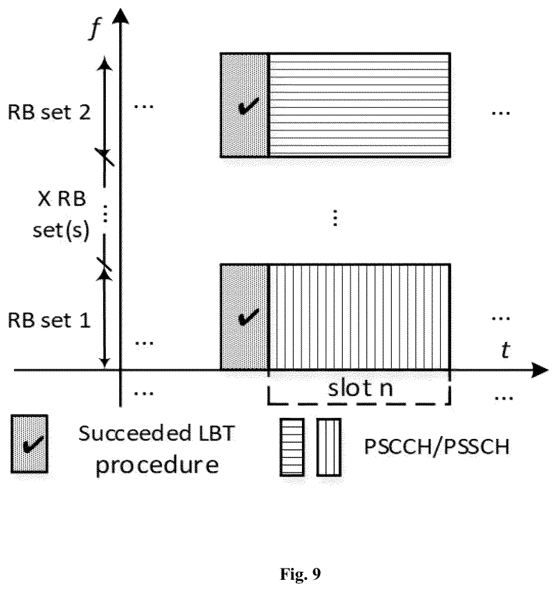

For example, after sensing N noncontiguous (or partial contiguous) RB sets to be idle for transmissions with aligned starting symbols on all RB sets (as a set of channels C), as shown in FIG. 9, the corresponding resource indication/reservation in SCI and/or MAC-CE may be enhanced/introduced based on the differences of channels. The new content may be introduced in 3GPP TS as below:

When the higher layer parameter useInterlacePSCCH-PSSCH/useInterlaceSL is configured, 5 + Y or
6 + Y bits may be introduced to SCI format to provide the frequency domain resource assignment if
the SCS for the resource pool is 30 kHz or 15 kHz respectively and interlaced resource blocks is
configured/enabled for sidelink transmission.

| | |
|---|---|
| • | $The value of Y is determined by 2 * {N}_{RB - set}^{Res - Pool} when the value of higher layer parameter$ |
| | $sl - MaxNumPerReserve is configured to 2 , otherwise 3 * {N}_{RB - set}^{Res - Pool} bits when the value of the$ |
| | $higher layer parameter sl - MaxNumPerReserve is configured to 3 , {N}_{RB - set}^{Res - Pool} is the$ |
| | number of RB sets contained in the resource pool of the active BWP. The FRIV in RB set |
| | $granularity for each reservation is expressed in a form of bitmap length {N}_{RB - set}^{Res - Pool} , each bit in$ |
| | the bitmap corresponds to a RB set in a set of channels C. |

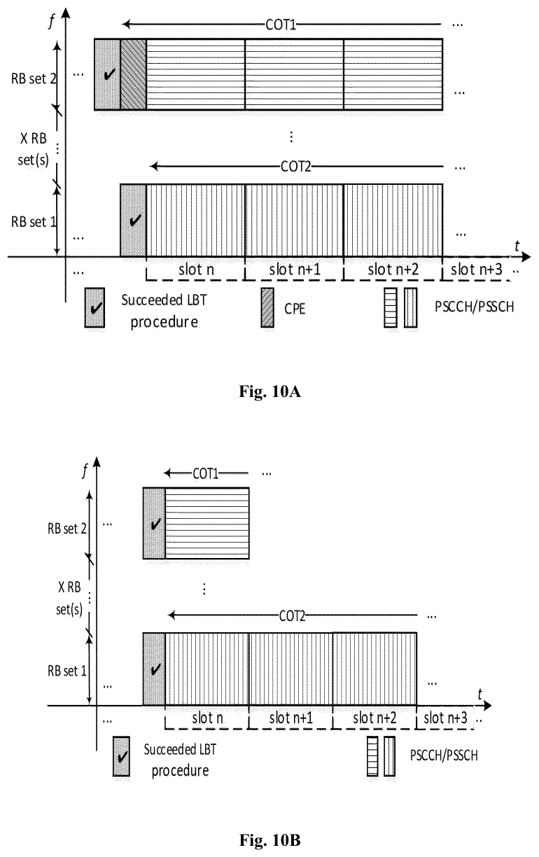

In some embodiments, the assigned interlace indices (5 or 6 bits) may be common to all RB sets and all reservations. Alternatively, separate interlace indices may be indicated for each RB set and/or each reservation. If the higher layer parameter useInterlacePSCCH-PSSCH/useInterlaceSL is not configured, interlace indices indication filed is omitted, 0 bit needed. Based on the unified channel access procedure on all RB sets or independent channel access procedures on each RB set, the CO indication may be common to all RB sets, as shown in FIG. 10A, or indicated per RB set, respectively, as shown in FIG. 10B. Further, given RB set(s), separate CO may be indicated related to each reservation.

For the other information in legacy, such as resource reservation period, modulation and coding scheme, additional MCS table indicator and etc., these parameters may be common to all RB sets and all reservations. Alternatively, these parameters may be separately indicated for each RB set and/or for each reservation.

The SCI may be conveyed through only one RB set which can be the lowest RB set in frequency domain, or a randomly selected RB set in C. Then, the single SCI shall carry all resource indications/reservations on all RB sets, the information related to each RB set may be varied. Alternatively, the SCI may be equally applied to all RB sets to improve the performance of SCI reception for Rx UE by diversity reception.

### Multiple Starting Symbols

In some embodiments, the information includes an indication being determined based on the number of the multiple of spectrum sections in a resource pool, the indication being for a plurality of noncontiguous spectrum sections of the plurality of spectrum sections. The transmissions on the plurality of noncontiguous spectrum sections have a first starting symbol and one or more additional starting symbols after the first starting symbol within a slot. Namely, the starting points of the transmissions on the plurality of noncontiguous spectrum sections are misaligned within a slot. The transmission on each spectrum section may start at the first starting symbol or at the additional starting symbol(s) with a slot. And the information further indicates a subset of the plurality of noncontiguous spectrum sections with the transmissions having one or more additional starting symbols.

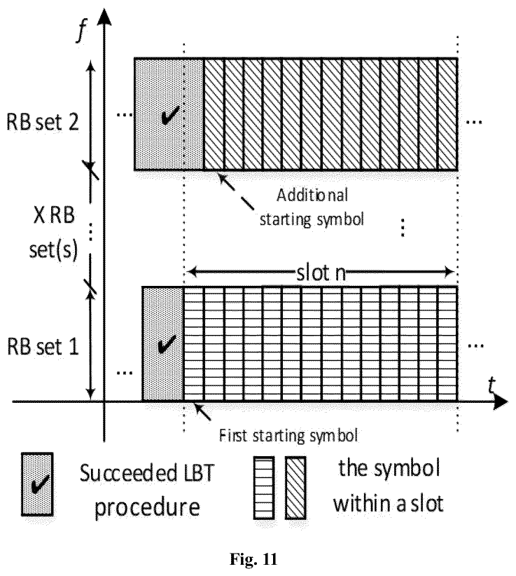

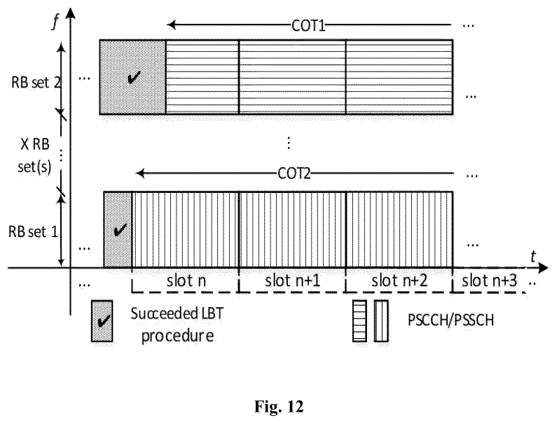

For example, assuming additional starting symbol(s) within a slot is supported for SL-U. If M (M<N) out of N RB sets are sensed to be idle immediately before the first starting symbol in a slot for transmissions on M RB sets, while the channel access procedure(s) on the other N-M RB set(s) is still in progress pending on the sensing result on the additional starting symbol(s), as shown in FIG. 11, the corresponding resource indication/reservation in SCI and/or MAC-CE may be enhanced/introduced based on the differences of channels considering following elements. The new content may be introduced in 3GPP TS as below:

When the higher layer parameter useInterlacePSCCH-PSSCH/useInterlaceSL is configured, 5 + Y + N
or 6 + Y + N bits may be introduced to SCI format to provide the frequency domain resource
assignment if the SCS for the resource pool is 30 kHz or 15 kHz respectively and interlaced resource
blocks is configured/enabled for sidelink transmission.

| | |
|---|---|
| • | $The value of Y is determined by 2 * {N}_{RB - set}^{Res - Pool} when the value of higher layer parameter$ |
| | $sl - MaxNumPerReserve is configured to 2 , otherwise 3 * {N}_{RB - set}^{Res - Pool} bits when the value of the$ |
| | $higher layer parameter sl - MaxNumPerReserve is configured to 3 , {N}_{RB - set}^{Res - Pool} is the$ |
| | number of RB sets contained in the resource pool of the active BWP. |
| • | Each bit in the N-bit set indicates whether Tx UE would perform potential transmission from |
| | the additional starting symbol(s) within the current slot on corresponding RB set in C which is |
| | indicated by Y bits as above sub-bullet. |

In some embodiments, the assigned interlace indices (5 or 6 bits) may be common to all RB sets and all reservations. Alternatively, separate interlace indices may be indicated for each RB set and/or each reservation. If the higher layer parameter useInterlacePSCCH-PSSCH/useInterlaceSL is not configured, interlace indices indication filed is omitted, 0 bit needed. Based on the independent channel access procedures on each RB set, the CO indication may be indicated per RB set, as shown in FIG. 12. Further, given RB set(s), separate CO may be indicated related to each reservation.

In some embodiments, for the other information in legacy, such as resource reservation period, modulation and coding scheme, additional MCS table indicator and etc., these parameters may be common to all RB sets and all reservations. Alternatively, these parameters may be separately indicated for each RB set and/or for each reservation.

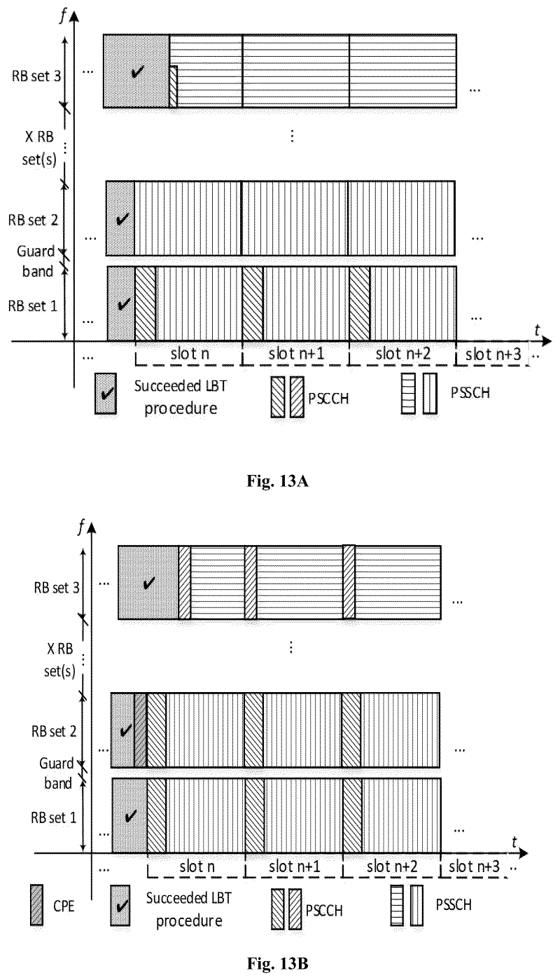

For M RB sets with transmissions from the first starting symbol, the corresponding SCI may be conveyed through only one RB set which can be the lowest RB set from M RB sets in frequency domain, or a randomly selected RB set from M RB sets. Then, the single SCI shall carry all resource indications/reservations on all M RB sets, as shown in FIG. 13A, the information related to each RB set may be varied. Alternatively, the SCI may be equally applied to all M RB sets to improve the performance of SCI reception for Rx UE by diversity reception, as shown in FIG. 13B. For the N-M RB set(s) with transmissions from additional starting symbol(s), the SCI corresponding to M RB sets may be shared except the CO indication. Alternatively, separate SCI for N-M RB set(s) may be indicated per RB set.

### Same RB Sets for Each Reservation

In some embodiments, the plurality of spectrum sections are the same for the at least one reserved resource.

For example, after sensing N RB sets to be idle for transmissions on all RB sets (from same or different starting symbol in a slot), aiming to transmit on the same RB sets across continuous slots within the maximum CO time, the corresponding resource indication/reservation in SCI and/or MAC-CE may be enhanced/introduced based on the differences of channels. The new content may be introduced in 3GPP TS as below:

If higher layer parameter useInterlacePSCCH-PSSCH/useInterlaceSL is configured, 5 + Y or 6 + Y bits
may be introduced to SCI format to provide the enhanced frequency domain resource assignment
if the SCS for the resource pool is 30 kHz or 15 kHz respectively and interlaced resource blocks is
configured/enabled for sidelink transmission.
if only contiguous RB sets is supported for SL-U, the value of Y is determined by
$⌈ {log}_{2} ( {N}_{RB - set}^{Res - Pool} ) ⌉ when the value of the higher layer parameter sl - MaxNumPerReserve is$
$configured to 2 or 3 , where {N}_{RB - set}^{Res - Pool} is the number of RB sets contained in the resource pool of$
the active BWP.

| | |
|---|---|
| - | If sl-MaxNumPerReserve is 2 or 3 then for FRIV in RB set granularity |
| - | $FRIV = {n}_{RB - set}^{start} + {\sum }_{i = 1}^{{L}_{RB - set} - 1} ( {N}_{RB - set}^{Res - Pool} + 1 - i )$ |
| - | ${n}_{RB - set}^{start} denotes the starting RB set index for the sefcond resource and third resource$ |
| - | L_{RB-set} denotes the number of RB sets scheduled or configured for transmission |

If non-contiguous RB sets is supported, or additional starting symbol(s) is supported, the value of Y
$is determinded by {N}_{RB - set}^{Res - Pool} when the value of the higher layer parameter sl - MaxNumPerReserve$
$is configured to 2 or 3 , where {N}_{RB - set}^{Res - Pool} is the number of RB sets contained in the resource pool$
of the active BWP. The FRIV in RB set granularity for each reservation is expressed in a form of
$bitmap length {N}_{RB - set}^{Res - Pool} , each bit in the bitmap corresponds to a RB set in C .$

In some embodiments, the assigned interlace indices (5 or 6 bits) may be common to all RB sets and all reservations. Alternatively, separate interlace indices may be indicated for each RB set and/or each reservation. If the higher layer parameter useInterlacePSCCH-PSSCH/useInterlaceSL is not configured, interlace indices indication filed is omitted, 0 bit needed. Based on the independent channel access procedures and/or different starting symbols/points on each RB set transmission from on, the CO indication may be indicated per RB set. Alternatively, by the united channel access procedures and aligned starting points on all RB sets, the common CO indication may be indicated for all RB sets. Furthermore, given RB set(s), separate CO may be indicated related to each reservation.

In some embodiments, for the other information in legacy, such as resource reservation period, modulation and coding scheme, additional MCS table indicator and etc., these parameters may be common to all RB sets and all reservations. Alternatively, these parameters may be separately indicated for each RB set and/or for each reservation.

In some embodiments, the SCI may be conveyed through only one RB set which can be the lowest (or randomly selected) RB set within M RB sets with transmissions from the first starting symbol. Alternatively, the SCI may be equally applied to all M RB sets. For the N-M RB set(s) with transmissions from additional starting symbol, the SCI corresponding to M RB sets may be shared except the CO indication. Alternatively, separate SCI for N-M RB set(s) may be indicated per RB set.

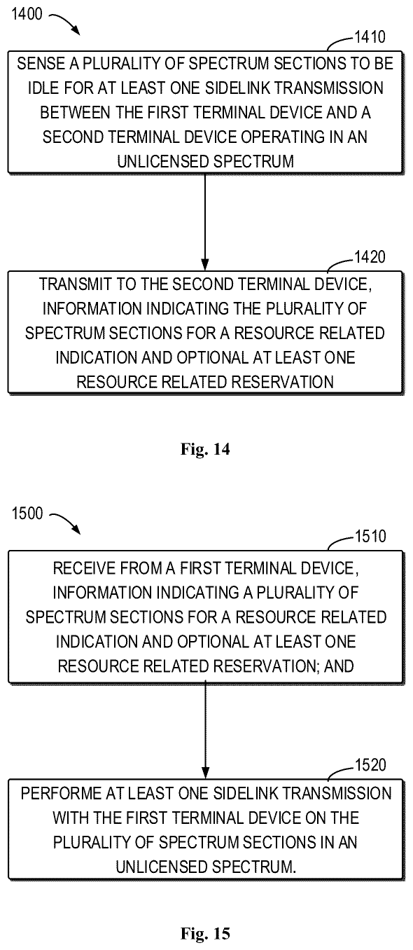

FIG. 14 shows a flowchart of an example method 1400 implemented at the first terminal device 110 in accordance with some example embodiments of the present disclosure. For the purpose of discussion, the method 1400 will be described from the perspective of the first terminal device 110 with respect to FIGS. 1 and 4.

At block 1410, the first terminal device 110 senses a plurality of spectrum sections to be idle for at least one sidelink transmission between the first terminal device 110 and a second terminal device 120 operating in an unlicensed spectrum. At block 1420, the first terminal device transmits to the second terminal device 120, information indicating the plurality of spectrum sections for a resource allocation.

In some embodiments, the information includes an indication being determined based on the number of resource reservations and the number of the multiple of spectrum sections in a resource pool, the indication being for a plurality of contiguous spectrum sections of the plurality of spectrum sections; and the transmissions on the plurality of contiguous spectrum sections have aligned starting symbols within a sidelink slot.

In some embodiments, the information includes an indication being determined based on the number of the multiple of spectrum sections in a resource pool, the indication being for a plurality of noncontiguous spectrum sections of the plurality of spectrum sections; and the transmissions on the plurality of noncontiguous spectrum sections have aligned starting symbols within a slot.

In some embodiments, the information includes an indication being determined based on the number of the multiple of spectrum sections in a resource pool, the indication being for a plurality of noncontiguous spectrum sections of the plurality of spectrum sections; the transmissions on the plurality of noncontiguous spectrum sections have a first starting symbol and one or more additional starting symbols after the first starting symbol; and the information further indicates a subset of the plurality of noncontiguous spectrum sections with the transmissions having one or more additional starting symbols.

In some embodiments, the plurality of spectrum sections are the same for the at least one reserved resource. The information further indicates indexes of a plurality of interlaced spectrums in each of the plurality of spectrum sections, and the indicated indexes of the plurality of interlaced spectrums are common to at least one of the plurality of spectrum sections and the at least one reserved resource.

In some embodiments, the information further indicates a plurality of interlaced spectrums in each of the plurality of spectrum sections individually. The information further indicates a plurality of interlaced spectrum in each of at least one resource reservation individually. The information comprises at least one channel occupancy (CO) indication for the at least one sidelink transmission.

In some embodiments, each of the at least one CO indication comprises at least a channel occupancy starting point indication and a remaining channel occupancy duration indication. The at least one CO indication comprises a CO indication common to at least one of the plurality of spectrum sections and at least one resource reservation. The at least one CO indication comprises a plurality of CO indications used for indicating COs for the plurality of spectrum sections separately. The information further indicates at least one of the following parameters for each of the plurality of spectrum sections individually: a resource reservation period; a MSC or an additional MCS table indicator.

In some embodiments, the information is transmitted through a selected spectrum section of the plurality of spectrum sections. The selected spectrum section is a lowest spectrum section in frequency domain or a randomly selected spectrum section in the plurality of spectrum sections. The information is transmitted through the plurality of spectrum sections, and a spectrum section of the plurality of spectrum sections carries a corresponding part of the information associated with the spectrum section. The information is comprised in sidelink control information (SCI) and optionally in a medium access control (MAC)-control element (CE).

FIG. 15 shows a flowchart of an example method 1500 implemented at the second terminal device 120 in accordance with some example embodiments of the present disclosure. For the purpose of discussion, the method 1500 will be described from the perspective of the second terminal device 120 with respect to FIGS. 1 and 4.

At block 1510, the second terminal device 120 receives from first terminal device 110, information indicating a plurality of spectrum sections for a resource allocation. At block 1520, the second terminal device 120 performs at least one sidelink transmission with the first terminal device 110 on the plurality of spectrum sections in an unlicensed spectrum.

In some embodiments, the information includes an indication being determined based on the number of resource reservations and the number of the multiple of spectrum sections in a resource pool, the indication being for a plurality of contiguous spectrum sections of the plurality of spectrum sections; and the transmissions on the plurality of contiguous spectrum sections have aligned starting symbols within a sidelink slot.

In some embodiments, the information includes an indication being determined based on the number of the multiple of spectrum sections in a resource pool, the indication being for a plurality of noncontiguous spectrum sections of the plurality of spectrum sections. And the transmissions on the plurality of noncontiguous spectrum sections have aligned starting symbols within a slot. The information includes an indication being determined based on the number of the multiple of spectrum sections in a resource pool, the indication being for a plurality of noncontiguous spectrum sections of the plurality of spectrum sections. And the transmissions on the plurality of noncontiguous spectrum sections have a first starting symbol and one or more additional starting symbols after the first starting symbol; and the information further indicates a subset of the plurality of spectrum sections with the transmissions having one or more additional starting symbols.

In some embodiments, the plurality of spectrum sections are the same for the at least one reserved resource. The information further indicates indexes of a plurality of interlaced spectrum in each of the plurality of spectrum section, and the indicted indexes of the plurality of interlaced spectrums are common to at least one of the plurality of spectrum sections and the at least one reserved resource. The information further indicates a plurality of interlaced spectrums in each of the plurality of spectrum sections individually.

In some embodiments, the information further indicates a plurality of interlaced spectrum in each of the at least one reserved resource individually. The information comprises at least one channel occupancy (CO) indication for the at least one sidelink transmission. And each of the at least one CO indication comprises at least a channel occupancy starting point indication and a remaining channel occupancy duration indication.

In some embodiments, the at least one CO indication comprises a CO indication common to at least one of the plurality of spectrum sections and at least one resource reservation. And the at least one CO indication comprises a plurality of CO indications used for indicating COs for the plurality of spectrum sections separately. The information further indicates at least one of the following parameters for each of the plurality of spectrum sections individually: a resource reservation period; a MSC or an additional MCS table indicator.

In some embodiments, the information is transmitted through a selected spectrum section of the plurality of spectrum sections. And the selected spectrum section is a lowest spectrum section or a randomly selected spectrum section in the plurality of spectrum sections. The information is transmitted through the plurality of spectrum sections, and a spectrum section of the plurality of spectrum sections carries a corresponding part of the information associated with the spectrum sections. The information is compriseed in sidelink control information (SCI) and optionally in a medium access control (MAC)-control element (CE).

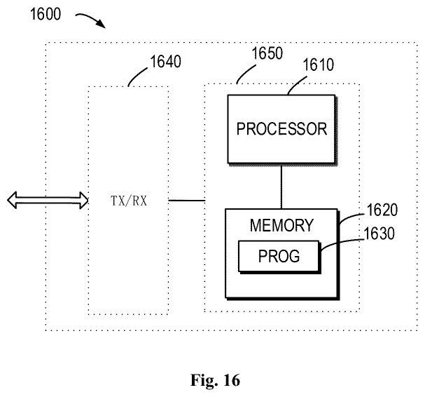

FIG. 16 is a simplified block diagram of a device 1600 that is suitable for implementing some embodiments of the present disclosure. The device 1600 can be considered as a further example embodiment of the terminal devices 110, 120 and network device 130 as shown in FIG. 1. Accordingly, the device 1600 can be implemented at or as at least a part of the above network devices or terminal devices.

As shown, the device 1600 includes a processor 1610, a memory 1620 coupled to the processor 1610, a suitable transmitter (TX) and receiver (RX) 1640 coupled to the processor 1610, and a communication interface coupled to the TX/RX 1640. The memory 1620 stores at least a part of a program 1630. The TX/RX 1640 is for bidirectional communications. The TX/RX 1640 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1630 is assumed to include program instructions that, when executed by the associated processor 1610, enable the device 1600 to operate in accordance with the embodiments of the present disclosure, as discussed herein with reference to FIGS. 2-15. The embodiments herein may be implemented by computer software executable by the processor 1610 of the device 1600, or by hardware, or by a combination of software and hardware. The processor 1610 may be configured to implement various embodiments of the present disclosure. Furthermore, a combination of the processor 510 and memory 520 may form processing means 1650 adapted to implement various embodiments of the present disclosure.

The memory 1620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1620 is shown in the device 1600, there may be several physically distinct memory modules in the device 500. The processor 1610 may be of any type suitable to the local technical network, and may include one or more of general purpose computers, special purpose computers, microprocessors, digital signal processors (DSPs) and processors based on multicore processor architecture, as non-limiting examples. The device 1600 may have multiple processors, such as an application specific integrated circuit chip that is slaved in time to a clock which synchronizes the main processor.

In some embodiments, a terminal device comprises circuitry configured to perform method 1400 and/or 1500.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, technique terminal devices or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 2 to 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

In summary, embodiments of the present disclosure may provide the following solutions.

A method for communication, comprising: sensing, at a first terminal device, a plurality of spectrum sections to be idle for at least one sidelink transmission between the first terminal device and a second terminal device operating in an unlicensed spectrum; and transmitting, to the second terminal device, information indicating the plurality of spectrum sections for a resource allocation.

In some embodiments, the information includes an indication being determined based on the number of resource reservations and the number of the plurality of spectrum sections in a resource pool, the indication being for a plurality of contiguous spectrum sections of the plurality of spectrum sections; and the transmissions on the plurality of contiguous spectrum sections have aligned starting symbols within a sidelink slot.

In some embodiments, the information includes an indication being determined based on the number of the plurality of spectrum sections in a resource pool, the indication being for a plurality of noncontiguous spectrum sections of the plurality of spectrum sections; and the transmissions on the plurality of noncontiguous spectrum sections have aligned starting symbols within a sidelink slot.

In some embodiments, the information includes an indication being determined based on the number of the plurality of spectrum sections in a resource pool, the indication being for a plurality of noncontiguous spectrum sections of the plurality of spectrum sections; the transmissions on the plurality of noncontiguous spectrum sections have a first starting symbol and one or more additional starting symbols after the first starting symbol within a sidelink slot; and the information further indicates a subset of the plurality of noncontiguous spectrum sections with the transmissions having one or more additional starting symbols.

In some embodiments, the plurality of spectrum sections are the same for at least one reserved resource.

In some embodiments, the information further indicates indexes of a plurality of interlaced spectrums in each of the plurality of spectrum sections, and the indicated indexes of the plurality of interlaced spectrums are common to at least one of the plurality of spectrum sections and at least one reserved resource.

In some embodiments, the information further indicates a plurality of interlaced spectrums in each of the plurality of spectrum sections individually.

In some embodiments, the information further indicates a plurality of interlaced spectrum in each of at least one reserved resource individually.

In some embodiments, the information comprises at least one channel occupancy (CO) indication for the at least one sidelink transmission, the CO indication comprises at least a channel occupancy starting point indication and a remaining channel occupancy duration indication.

In some embodiments, the at least one CO indication comprises a CO indication common to at least one of the plurality of spectrum sections and at least one reserved resource.

In some embodiments, the at least one CO indication comprises a plurality of CO indications used for indicating COs for the plurality of spectrum sections separately.

In some embodiments, the information further indicates at least one of the following parameters for each of the plurality of spectrum sections individually: a resource reservation period; a modulation and coding scheme (MCS); or an additional MCS table indicator.

In some embodiments, transmitting, the information comprises: transmitting, the information through a selected spectrum section of the plurality of spectrum sections

In some embodiments, the selected spectrum section is a lowest spectrum section in frequency domain or a randomly selected spectrum section in the plurality of spectrum sections.

In some embodiments, the information is transmitted through the plurality of spectrum sections, and a spectrum section of the plurality of spectrum sections carries a corresponding part of the information associated with the spectrum section.

In some embodiments, the information is comprised in sidelink control information (SCI) and optionally in medium access control (MAC)-control element (CE).

A method for communication, comprising: receiving, at a second terminal device from a first terminal device, information indicating a plurality of spectrum sections for a resource allocation; and performing at least one sidelink transmission with the first terminal device on the plurality of spectrum sections in an unlicensed spectrum.

In some embodiments, the information includes an indication being determined based on the number of resource reservations and the number of the plurality of spectrum sections in a resource pool, the indication being for a plurality of contiguous spectrum sections of the plurality of spectrum sections; and the transmissions on the plurality of contiguous spectrum sections have aligned starting symbols within a sidelink slot.

In some embodiments, the information includes an indication being determined based on the number of the plurality of spectrum sections in a resource pool, the indication being for a plurality of noncontiguous spectrum sections of the plurality of spectrum sections; and the transmissions on the plurality of noncontiguous spectrum sections have aligned starting symbols within a sidelink slot.

In some embodiments, the information includes an indication being determined based on the number of the plurality of spectrum sections in a resource pool, the indication being for a plurality of noncontiguous spectrum sections of the plurality of spectrum sections; the transmissions on the plurality of noncontiguous spectrum sections have a first starting symbol and one or more additional starting symbols after the first starting symbol within a sidelink slot; and the information further indicates a subset of the plurality of spectrum sections with the transmissions having one or more additional starting symbols.

In some embodiments, the plurality of spectrum sections are the same for at least one reserved resource.

In some embodiments, the information further indicates indexes of a plurality of interlaced spectrum in each of the plurality of spectrum section, and the indicted indexes of the plurality of interlaced spectrums are common to at least one of the plurality of spectrum sections and at least one reserved resource.

In some embodiments, the information further indicates a plurality of interlaced spectrums in each of the plurality of spectrum sections individually.

In some embodiments, the information further indicates a plurality of interlaced spectrum in each of at least one reserved resource individually.

In some embodiments, the information comprises at least one channel occupancy (CO) indication for the at least one sidelink transmission, each of the at least one CO indication comprising at least a channel occupancy starting point indication and a remaining channel occupancy duration indication.

In some embodiments, the at least one CO indication comprises a CO indication common to at least one of the plurality of spectrum sections and at least one reserved resource.

In some embodiments, the at least one CO indication comprises a plurality of CO indications used for indicating COs for the plurality of spectrum sections separately.

In some embodiments, the information further indicates at least one of the following parameters for each of the plurality of spectrum sections individually: a resource reservation period; a modulation and coding scheme (MCS); or an additional MCS table indicator.

In some embodiments, transmitting, the information comprises: transmitting, the information through a selected spectrum section of the plurality of spectrum sections.

In some embodiments, the selected spectrum section is a lowest spectrum section in frequency domain or a randomly selected spectrum section in the plurality of spectrum sections.

In some embodiments, the information is transmitted through the plurality of spectrum sections, and a spectrum section of the plurality of spectrum sections carries a corresponding part of the information associated with the spectrum section.

In some embodiments, the information is comprised in sidelink control information (SCI) or in medium access control (MAC)-control element (CE).

A first terminal device comprising: a processor; and a memory storing computer program code; the memory and the computer program code configured to, with the processor, cause the terminal device to perform the method according to any of above methods.

A second terminal device comprising: a processor; and a memory storing computer program code; the memory and the computer program code configured to, with the processor, cause the network device to perform the method according to any of above methods.

A computer readable medium having instructions stored thereon, the instructions, when executed by a processor of an apparatus, causing the apparatus to perform the method according to any of above methods.

1.-20. (canceled)

21. A method performed by a first terminal device, comprising:
transmitting sidelink control information (SCI) comprising frequency resource assignment information,
wherein based on a higher layer parameter being configured to an interlace resource block (RB) for physical sidelink control channel (PSCCH)/physical sidelink shared channel (PSSCH) transmission, a first number of bits in the frequency resource assignment information provides RB set allocation, and the bits are associated with configured value of maximum number of reserved PSCCH/PSSCH resources; and
performing the PSSCH transmission associated with the SCI.

22. The method of claim 21, wherein the first number is determined by
$$⌈ {log}_{2} ( \frac{{N}_{RB - set}^{Res - Pool} ( {N}_{RB - set}^{Res - Pool} + 1 )}{2} ) ⌉$$
when value of the higher layer parameter sl-MaxNumPerReserve is configured to 2, or determined by
$$⌈ {log}_{2} ( \frac{{N}_{RB - set}^{Res - Pool} ( {N}_{RB - set}^{Res - Pool} + 1 ) ( 2 {N}_{RB - set}^{Res - Pool} + 1 )}{6} ) ⌉$$
when the value of the higher layer parameter sl-MaxNumPerReserve is configured to 3, where
$${N}_{RB - set}^{Res - Pool}$$
is number of RB sets in a resource pool.

23. The method of claim 21, wherein based on the higher layer parameter being configured to interlace RB for PSCCH/PSSCH transmission, applied interlace index(s) in different RB sets are the same.

24. The method of claim 21, further comprising: accessing multiple channels on which the PSCCH/PSSCH transmission are performed, in response to the PSCCH/PSSCH transmission are to start at the same time on all channels in the multiple channels.

25. The method of claim 24, further comprising:
initiating a channel occupancy (CO) using a channel access procedure on the multiple channels, wherein the SCI further comprises a channel occupancy (CO) indication, and CO time of each channel is the same.

26. The method of claim 22, further comprising:
determining frequency resource for the PSSCH transmission comprising:
if sl-MaxNumPerReserve is 2 then for frequency resource indicator value (FRIV) in RB set granularity
$$FRIV = {n}_{RB - set , 1}^{start} + {\sum }_{i = 1}^{{L}_{RB - set} - 1} ( {N}_{RB - set}^{Res - Pool} + 1 - i ) ,$$
if sl-MaxNumPerReserve is 3 then for FRIV in RB set granularity
$$FRIV = {n}_{RB - set , 1}^{start} + {n}_{RB - set , 2}^{start} \cdot ( {N}_{RB - set}^{Res - Pool} + 1 - {L}_{RB - set} ) + {\sum }_{i = 1}^{{L}_{RB - set} - 1} {( {N}_{RB - set}^{Res - Pool} + 1 - i )}^{2} ,$$
where
$${n}_{RB - set , 1}^{start}$$
denotes a starting RB set index for a second resource
$${n}_{RB - set , 2}^{start}$$
denotes the starting AB set index for a third resource
L_{RB-set} denotes number of RB sets scheduled or configured for transmission
$${N}_{RB - set}^{Res - Pool}$$
is number of KB sets in a resource pool.

27. A method performed by a second terminal device, comprising:
receiving sidelink control information (SCI) comprising frequency resource assignment information,
wherein based on a higher layer parameter being configured to an interlace resource block (RB) for physical sidelink control channel (PSCCH)/physical sidelink shared channel (PSSCH) transmission, a first number of bits in the frequency resource assignment information provides RB set allocation, and the bits are associated with configured value of maximum number of reserved PSCCH/PSSCH resources; and
performing PSSCH reception based on the SCI.

28. The method of claim 27, wherein the first number is determined by
$$⌈ {log}_{2} ( \frac{{N}_{RB - set}^{Res - Pool} ( {N}_{RB - set}^{RE - Pool} + 1 )}{2} ) ⌉$$
when value of the higher layer parameter sl-MaxNumPerReserve is configured to 2, or determined by
$$⌈ {log}_{2} ( \frac{{N}_{RB - set}^{Res - Pool} ( {N}_{RB - set}^{Res - Pool} + 1 ) ( 2 {N}_{RB - set}^{Res - Pool} + 1 )}{6} ) ⌉$$
when the value of the higher layer parameter sl-MaxNumPerReserve is configured to 3, where
$${N}_{RB - set}^{Res - Pool}$$
is number of RB sets in a resource pool.

29. The method of claim 27, wherein based on the higher layer parameter being configured to interlace RB for PSCCH/PSSCH transmission, applied interlace index(s) in different RB sets are the same.

30. The method of claim 27, wherein the SCI further comprises a channel occupancy (CO) indication, and CO time of each channel is the same.

31. The method of claim 28, further comprising:
determining frequency resource for the PSSCH transmission comprising:
if sl-MaxNumPerReserve is 2 then for frequency resource indicator value (FRIV) in RB set granularity
$$F R I V = {n}_{RB - set , 1}^{start} + {\sum }_{i = 1}^{{L}_{RB - set} - 1} ( {N}_{RB - set}^{Res - Pool} + 1 - i ) ,$$
if sl-MaxNumPerReserve is 3 then for FRIV in RB set granularity
$$F R I V = {n}_{RB - set , 1}^{start} + {n}_{RB - set , 2}^{start} \cdot ( {N}_{RB - set}^{Res - Pool} + 1 - {L}_{RB - set} ) + {\sum }_{i = 1}^{{L}_{RB - set} - 1} {( {N}_{RB - set}^{Res - Pool} + 1 - i )}^{2} ,$$
where
$${n}_{RB - set , 1}^{start}$$
denotes a starting KB set index for a second resource
$${n}_{RB - set , 2}^{start}$$
denotes the starting AB set index for a third resource
L_{RB-set} denotes number of RB sets scheduled or configured for transmission
$${N}_{RB - set}^{Res - Pool}$$
is number of KB sets in a resource pool.

32. A first terminal device, comprising a processor configured to:
transmit sidelink control information (SCI) comprising frequency resource assignment information,
wherein based on a higher layer parameter being configured to an interlace resource block (RB) for physical sidelink control channel (PSCCH)/physical sidelink shared channel (PSSCH) transmission, a first number of bits in the frequency resource assignment information provides RB set allocation, and the bits are associated with configured value of maximum number of reserved PSCCH/PSSCH resources; and
perform the PSSCH transmission associated with the SCI.

33. The first terminal device of claim 32, wherein the first number is determined by
$$⌈ {log}_{2} ( \frac{{N}_{RB - set}^{Res - Pool} ( {N}_{RB - set}^{RE - Pool} + 1 )}{2} ) ⌉$$
when value of the higher layer parameter sl-MaxNumPerReserve is configured to 2, or determined by
$$⌈ {log}_{2} ( \frac{{N}_{RB - set}^{Res - Pool} ( {N}_{RB - set}^{Res - Pool} + 1 ) ( 2 {N}_{RB - set}^{Res - Pool} + 1 )}{6} ) ⌉$$
when the value of the higher layer parameter sl-MaxNumPerReserve is configured to 3, where N_{RB-set}^{Res-Pool} is number of RB sets in a resource pool.

34. The first terminal device of claim 32, wherein based on the higher layer parameter being configured to interlace RB for PSCCH/PSSCH transmission, applied interlace index(s) in different RB sets are the same.

35. The first terminal device of claim 32, wherein the processor is further configured to cause the first terminal device to:
access multiple channels on which the PSCCH/PSSCH transmission are performed, in response to the PSCCH/PSSCH transmission are to start at the same time on all channels in the multiple channels.

36. The first terminal device of claim 35, wherein the processor is further configured to cause the first terminal device to:
initiate a channel occupancy (CO) using a channel access procedure on the multiple channels, wherein the SCI further comprises a channel occupancy (CO) indication, and CO time of each channel is the same.

37. The first terminal device of claim 33, wherein the processor is further configured to cause the first terminal device to:
determining frequency resource for the PSSCH transmission comprising:
if sl-MaxNumPerReserve is 2 then for frequency resource indicator value (FRIV) in RB set granularity
$$F R I V = {n}_{RB - set , 1}^{start} + {\sum }_{i = 1}^{{L}_{RB - set} - 1} ( {N}_{RB - set}^{Res - Pool} + 1 - i ) ,$$
if sl-MaxNumPerReserve is 3 then for FRIV in RB set granularity
$$F R I V = {n}_{RB - set , 1}^{start} + {n}_{RB - set , 2}^{start} \cdot ( {N}_{RB - set}^{Res - Pool} + 1 - {L}_{RB - set} ) + {\sum }_{i = 1}^{{L}_{RB - set} - 1} {( {N}_{RB - set}^{Res - Pool} + 1 - i )}^{2} ,$$
where
$${n}_{RB - set , 1}^{start}$$
denotes a starting KB set index for a second resource
$${n}_{RB - set , 2}^{start}$$
denotes the starting RB set index for a third resource
L_{RB-set} denotes number of RB sets scheduled or configured for transmission
$${N}_{RB - set}^{Res - Pool}$$
is number of KB sets in a resource pool.
